(19) United States
(12) Patent Application Publication
(10) Pub. No.: US 2026/0045374 A1
(43) Pub. Date: Feb. 12, 2026

(54) QUANTUM KINETIC WELL (OMNIBUS)

(71) Applicant: McKane B. Lee, Arlington, WA (US)

(72) Inventor: McKane B. Lee, Arlington, WA (US)

(21) Appl. No.: 18/795,344

(22) Filed: Aug. 6, 2024

(51) Int. Cl. G21B 1/21; G21B 1/23

(52) U.S. Cl. CPC G21B 1/21; G21B 1/23

(57) ABSTRACT

Provided herein are fusion reactor devices that utilize electrical dynamic resistance within a resonant cavity. This is accomplished in conjunction with externally or internally magnetically affixed particle accelerator applications, inertial confinement, magnetic target fusion, field-reverse confinement, plasma accelerators, enhanced electro-coagulation, orbitron cylinder or linear magnetron/klystron, and stellarator designs to enhance space-charge polarization (fusion events) within dielectric mediums. This includes liquid water, water mist, gaseous matter, liquid metals, and even the vacuum of space.

### I. BACKGROUND

### A. Field of the Invention

This invention pertains to systems and methods for varying the space-charge polarization of dielectric mediums (protium, deuterium, tritium, helium, air moisture, liquid water, metal liquids and the even the vacuum of space) using resonant voltage transients rather than amperage in a purely physical process. The resulting voltage pressure is utilized to extract electrons directly from hydrogen, deuterium, tritium, and oxygen in order to promote fusion renormalization events (Triple-Alpha).

### B. Description of Related Art

In the case for electron's interacting with metal plate surface(s) such as capacitors i.e., antenna(s), the presence of free electrons in metals is revealed by phenomena other than electrical conduction, these include thermionic emission, radiation energy, cold-cathode primary emissions, secondary emissions scattering, and the photoelectric effect being particularly important examples [J=σE]. Free moving electrons, known as plasma, migrate upon the surface of a metal are not entirely “free” to leave the confines of the isolated piece of metal, if allowed.

It must be supposed that the surface of the metal presents some kind of “mild resistive barrier” preventing their escape under normal mode conditions, but the electrons are apparently able to move about within/without the metal in much the same way that gas molecules are free to move within the confines of the enclosing vessel (antenna). Electron's lines of force, known as the Coulomb law, provide inversely proportional electrostatic magnitudes (pointing vectors) of potential which are able/allowed to extend pass the perimeter of the atom (metal surface); ultimately invoking dielectric momentum in the form of space-charge polarization or electron donor holes (conductivity) when electrically energized by electromotive force (σ=ne²τ/m). The native behavior of the electron is to take the shortest path of least resistance (lines of force pathways i.e., flow) within a closed-loop circuit, if allowed. This flow rate (Faraday's Law) can be enhanced by quantum phenomenon (microscopic switching) within a transistor junction point(s) or modified sine wave inverter device (rectified square-waves). This can even take place inside a fluxing capacitor (macroscopic switch) utilizing a zero-reference grid/screen-plate inside the dielectric's permittivity. This is called a voltage crossover mode or a “flux capacitor” regime (bifurcated capacitor coupler). The momentum ρ of a free electron is related to the wavelength λ of the electronic wave between electrode surface(s) (Casmir Effect). Dynamic resistance to capacitive cell, which limits or re-routes the natural flow of electron field lines, and subsequently electrons themselves, can be altered, in unique ways, to induce dielectric space-charge renormalization event(s) not known by many in the of art plasma physics.

In the foregoing patent disclosure, various fusion research platform devices will be disclosed with a step-by-step engineered enhancement of space-charge polarization induced principles of “resistivity” to trigger Quantum Kinetic Well® fusion (as described in U.S. Pat. No. 11,233,421). Electron cavitations i.e., stimulate synthetic fusion/energy harvesting (electron extraction), electron/positron time-share rate manipulation, and negative differential electron pressures (dynamic resistivity) are just a few byproducts of these specific device(s). The operational Kelvin thermal temperatures typically reach between 11.6 million to +215 million degrees [1 keV−+20 keV] during pulsing operations with ocean water dielectric mediums. This physical approach to advanced plasma electrolysis, as a byproduct, renders elemental fusion or electro-transmutation. Atomic photon illumination glow (Aurora Borealis) X-rays begins with input(s) as low as/or between 1.9-3.2 watts/sec. This electron amplification phenomenon is possible because natural water, not known to many, is classified as a quantum semiconductor material.

There are several types of resistivity domains within in a “Closed-Loop” circuit. In order to trigger fusion events (photon excitation from inner atomic renormalization) in a liquid or air capacitor matrix, resistivity [dynamic resistance] must be obtained within a “Closed-Loop” dielectric capacitive network.

### Types of Resistivity

One, Ohms Law [R=V/I] is static resistance¹, which is typically a carbon/stainless steel element of wire cross-section such as the filament of a light bulb or resistive crystalline lattice of wire [electric load]. Two, [X_{C}=½πƒc] which is capacitive resistance/reactance² as the dielectric's ability or inability to flow current (dielectric constant) i.e., permittivity. Three, dynamic resistance³, which is triggered during diode behaviors [ΔR=ΔV/ΔI] and phase angle (phase vector) changes [Z=R+X_{L}−X_{C}] with inductor's reactance (X_{L}) and capacitor's dielectric reactance (X_{C}) tank circuits during resonance unipolar pulse train (X_{L}=X_{C}). This behavior is described as inducing electronic ground state [electron bounce phenomenon]. In this state, groundside electrons have inertial momentum force, but little to no drift velocity [non-relativistic inertia—i.e., standing wave]. Four, [∀×H=J] magnetic resistance⁴ (magneto-resistance i.e., electron gyroscope motion i.e. helix spiraling constriction), is the change of internal resistance corresponding to an applied electrostatic/magneto-static field (Stark & Zeeman Effect). This effect is triggered from an external change in conductivity by a [internal or external perpendicular bisector] magnetic field line(s) upon the free electrons. It should be noted; that Zeeman Effect(s) induced by external magnetic field lines causes atoms and even electrons to exaggerate native gyrate/wobble/jitter (Zitterbewegung). Magnetic resistance can also be found [and felt] in opposition via coil wires like bifilar, tri-filar and quad-filar coils (Intersymbol Interference-Cross-Talk). Five, [F=κQ1Q2/d²] the electrostatic resistances, the metallic enclosure (electrode having one or more perforated openings) permits electromagnetic coupling and can be used in conjunction with a screen-plate and grid-plate resistor or resistive load element(s) (constructive or de-constructive wave interference). The screen-plate electronically modulates or amplifies the flow of electrostatic charged electrons/photons/wavelets from cathode by swinging rapidly (+) positively and (−) negatively relative to distance squared from anode and cathode (Triode). This behavior confuses/delays the primary emission electron(s) emitted from cathode are ultimately impeded (enhanced superposition—bifurcation). This wave propagator of the superposition mechanism can also periodically cause spawning of more electrons near the ground state due to diffraction patterning events . . . The suppressor grid-plate lies between the screen grid and the anode and absorbs secondary electron scattering emissions from anode and dielectric displacement current readjustments increasing negative energy density state(s) (Pentode). We shall call this grid-plate electrode the “electron extractor grid-plate” (E.E.). Six, [ν=λƒ] the electromagnetic (photon) resistance, since electrons are electromagnetic spinor entities (Bessel Functions), they can be excited and de-excited (quantum thermodynamic orbital behaviors) by external impinging photon wave energy collisions. The frequency of light can vary from microwave [1.24 μeV-1.24 meV], infrared [1.24 meV-1.7 eV], visible light [2 eV-2.75 eV], ultra-violet [3 eV-30 eV], extreme ultra-violet [40 eV-91.6 eV], and X-rays [100 eV-100 keV]. Seven, [p=mv] particle accelerator momentum modes of operations to sequentially triggered exciting electrodes array and/or in conjunction with toroidal magnetic cores (Electromagnetic Induction). Eight, the geometric shape of cathode can be a sharp-point similar to a tapered cone or tip. Allowing the cathode to hover or rest 0.001-inches from or into the surface of the water, the electrons attempt to complete the “Closed-Loop” circuit, but are met by dynamic resistance force line bottlenecking effects. Enhancing, dynamic resistance to spark an instantaneous liquid to super-heated gas vapor explosion event via a quantum tunneling renormalization/perturbation by large local variations in field strength. Nine, [α_{c}=v²/r] the rotational and/or counter-rotational centrifugal and centrifugal resistance⁹ of anode to grid plate. A rotating anode (pro-grade) and counter rotational (retro-grade) pulsing grid-plate(s) in reference to the stationary cathode time-phase shifts the electrons field lines of force (Field-Reverse Confinement+Plasma Shear Flow effects) confusing (further impeding) the primary electron emissions and secondary emissions stemming from cathode to anode. This can also be stimulated by ionic flow through specially shaped electrodes like rings, domes, plates, tubes, semi-spheres, and saucer shapes (Coandá Effect). There are other dynamic resistive methods, those skilled in the art will design engineer for preferred embodiment.

It should be noted: the generation of internal secondary electrons (energy harvesting yield from kinetic scattering electrons) is determined by several factors. 1.) The intensity (voltage input) of particle oscillations i.e., kinetic resonant impact of the primary electrons from cathode emissions with dielectric mediums, neighboring electrodes and electro-magnetic radiation (photons). 2.) The electromotive force transport of the internal momentum of secondary electrons through the bulk of the anode/grid or suppressor grid surface(s). This is accomplished and enhanced with ionic particle accelerators (elastic and inelastic scattering). This is called: Secondary Reflections and Secondary Leakage. 3.) The escape angle and velocity of secondary electrons across the air-solid-liquid-vacuum (positrons, quarks, fermions, cosmic rays, and gluons) interface i.e., the permittivity of dielectric. 4.) The negative differential electron pressure associated with the coil arrangement design and the attenuated voltage inputs (Electron Venturi). These scattering electrons and sub-atomic particles can be re-directed with dynamic resistance features above (1-9).

The effects are quite complicated and have been known to exhibit spontaneous thermal run-away events i.e., Townsend Avalanche conditions. This can be dangerous and damage equipment (RCA: 6BK4—Shunt Regulator) but is necessary to vectored properly with timed pulse intensity for harvesting of “free” energy (excess spawning electrons). This is all done in a controlled safe unipolar pulsed manner by modulating voltage, electrode spacing, resonant cavity shapes, electrode material, electrode relativistic motion, vessel pressure, dielectric mediums and resonant frequencies influence the efficiency factor.

Incorporating all these features into a single base-mode (QKW®) fusion device will be called, “Arc Reactor™” i.e., Quantum Kinetic Well™[as disclosed in U.S. Pat. No. 11,233,421]. Which, we will enhance and retrofit to existing prior art technologies within this omnibus disclosure. Thus, transforming prior art fusion devices from purely research devices into revolutionary and fully functional fusion machines for commercial use in industry.

To establish efficient electron harvesting oscillations, resonance must be established in the “Closed-Loop” R.L.C. tank system [X_{L}=X_{C}]. This is done with a Single-Coil Transformer (SCT), Bi-Coil Transformer, (BCT), Tri-Coil Transformer (TCT) or even a Quad-Coil Transformer (QCT) is affixed to a capacitive network. Tri-Coil Transformer (TCT) provides the greatest ‘poly-phase’ electrical distribution, harvesting potential, due to the innate inner gyrating wobble of the electron—Zitterbewegung.

The resonant induced dynamic resistivity pulses within the Closed-Loop circuit are felt upon the dielectric as electron(s), instantly, as they are “sucked into a negative pressure void coefficient event”, which takes place near anode (Newton's Third Law). Resonant perturbations at the cathode side are felt instantly between the cathode and the anode (lines of force—snapping effect). For every action there is an equal and opposite reaction at the cathode side of the circuit where positively charge ‘weakened’ ions condense. As input voltage is increased, the capacitive ground state current decreases (resonance, magnetic field etc.). This enhanced physical mode of operation, which is 180-degrees out of phase “normal” Faraday electronics is the first step in triggering the effects of dynamic resistive dielectric fusion (Negative Differential Electron Pressure—Electrical Venturi) upon the anode.

Instead of a typical capacitor plate cell (cathode to anode electron transport chain) “electron discharge arc” [brute force field emission] stemming from the ground cathodes primary electrons (Faraday Electrolysis), the dielectric collapse discharge event happens as a result of time-varying electromagnetic momentum disturbances (nano-voids) with the dielectric's orbiting electrons and with the inner-atomic structure(s) i.e. Quantum Zero Point Energy of the dielectric medium, as will be described in detail herewith in connection with the present invention. The phenomenon is “Particle Oscillations as an Energy Generator.” Inherently, this synthetic mechanism softly bends the Second Law of Thermodynamics. Photonic energy renormalization includes: 1 keV-2.75 keV (Bremsstrahlung Electron Braking), 3.55 keV (Matter and Anti-Matter Oscillations), 6.4 keV (Iron Florescence), and 9 keV-18.6 keV (Fusion Plasma Ignition: Protium to Deuterium to Tritium to Helium Transmutation i.e., Proton-Proton Chain Reactions—Triple-Alpha). Super Soft Luminous X-ray radiation is typical byproducts of this type of fusion phenomenon (Compound Nucleus-Transient Ringing) as electrons lose internal self-kinetic energy and thus, as a byproduct of the force, fall into the nucleus (Quantum Kinetic Well®) QKW® stimulating micro-electron sized supernova events known as quantum tunneling.

The present disclosure will continue to develop the aforementioned concept, and affix it onto existing research fusion concepts such and not limited to magnetic confinement (MCF), inertial confinement (ICF), magnetic targeting (MTF), field-reverse confinement (FRCF), compression plasma fusion (CPF) stellarator (particle accelerators), plasma acceleration (PAF), oscillation avalanche fusion (OAF) and rotational disk electrodes (RDE). And ultimately, eloquently, we shall wrap all these electrical concepts into one single apparatus—The Arc Reactor™.

In modern electronics, a force called, “resistivity” or “dynamic resistance” within a Closed-Loop or Quasi-Closed Loop capacitor/antenna promotes synthetic Nucleosynthesis (condensed matter conjugate), gravity, and fusion events. This fundamental force uniformly stacks electrons/positrons into matter states (mass=potential light energy) to form our known Universe [E=+/−MC²]. It can be observed in nature visually by polar atmospheric Aurora Borealis (Earth's natural ionic fusion filtration system). This force is greatest at the polar regions of planets, suns and black holes. This is innately due to localized condensing fluxing mass-to-charge (Electrostatic) ratios and dense concentrations of magnetic field lines (Magnetism).

In the foregoing inventions, we will show how to resist or otherwise trap (resonant ballasting) flowing current and redirect into a new dielectric current for energy harvesting using electron extraction grid-plate(s) EE suppressor grid-plates and/or ionic accelerators. In short, turn a capacitor (an imaginary load) into a battery (real load).

Furthermore, this is the reciprocal of conductivity and known as “displacement current” [∂D/∂t] from a capacitor matrix polarization. It should be noted, “displacement current” or as James Clerk Maxwell called it, “electromagnetic momentum” is not an electric current of moving charges, but a time-varying electric field within polarized dielectric medium(s) . . . Oliver Heaviside coined this phenomenon, “The Extra-Current” in the telegraph lines pulses [L>R²C/4] back in 1876, which, in present embodiment application, will be used to enhance harvesting of electrons from capacitive matrix networks.

Another principle associated with “extra-current” is resonance electron scattering. The atom (or electron), are governed by the observed theory of quantum transitions (intra-band jumping) which, suggests the excitation or orbit jumps can be polarized giving rise to unique photonic frequencies emissions (atomic transmutation). This is a byproduct caused by localized renormalization (neutral particle resonant scattering) by resistivity fusion, electron time-share rate dilation and energy harvesting (electron extraction—Bessel wave distortions/absorption) is vectored for industry.

Those skilled in the art will design for desired “electromagnetic momentum” or synthetic gravitational stimulating results with dynamic resistance. Furthermore, gravity is the electron or electron(s) attempting to electrically discharge internal degrees of dimensional freedom (spinors) in a “Closed-Loop” circuit, but are not allowed to by space-charge polarization that is localized via a time-share fluxing dependent Maxwellian forces i.e. (electrostatic—MASS/CHARGE RATIO), ∀×E(r)=ρν (r)ε₀, (magnetic—ELECTRON SPINOR) ∀×B(r)=0, and (photons—ELECTROMAGNETIC RADIATION) ∀×B(r)=μ₀J+μ₀ε₀∂E/∂t. The key understanding here is that: E=+/−MC². Light radiates energy into the lower 3^{rd} dimension resulting in agitations between matter and anti-matter (3.55 keV emissions from newly forming galactic nebulas) as temporal flux changes.

### II. SUMMARY

Provided in this disclosure is a reactor device including electrodes having one or more of a positive electrode and a negative electrode. The electrodes are configured concentrically along a reactor axis to define a resonant cavity. A flow passage has an entrance port and exit port for flowing a dielectric medium into the resonant cavity. The electrodes create an electrostatic field throughout the flow passage to dissociate the dielectric medium. A plurality of resonant coils are configured concentrically along the reactor axis to surround the electrodes and thereby axially wrap the resonant cavity. Each of the plurality of resonant coils are selected from frequency bypass, amp inhibiting, secondary, or pick-up coils. A stationary or rotating laser cluster array is provided for pulsing light intensity and targeting electron orbitals in the dielectric medium in the flow passage to dissociate the dielectric medium.

The electrodes include one or more perforated grid-plate/rings centrically mounted respectively between the positive electrode and the negative electrode to aid dynamic resistivity. The reactor device can include a longitudinal housing having a first longitudinal end and a second longitudinal end with a center therebetween. Both longitudinal ends lie along the reactor axis. The laser cluster array can include components mounted in at least one longitudinal end, and directed toward the center of the longitudinal housing. The entrance port of the flow passage is mounted in the first longitudinal end and the exit port is mounted in the second longitudinal end so that dissociation occurs at the center.

In one embodiment, the electrodes include first and second sets of electrodes conically tapered toward the center. The plurality of resonant coils include first and second sets of resonant coils configured concentrically along the reactor axis to respectively surround the first and second sets of electrodes. Each of the first and second sets of resonant coils are in a linear configuration of an amp inhibiting coil, three frequency bypass coils, and a secondary coil along the reactor axis from a respective longitudinal end to the center.

In another embodiment, the electrodes can include one more stack of capacitive plates. The plurality of resonant coils are configured concentrically along the reactor axis to respectively surround the capacitive plates. In this embodiment, the resonant coils are in a linear configuration of two amp inhibiting coils, a secondary coil, and a pick-up coil along the reactor axis.

In yet another embodiment, the positive electrode is configured proximate to one of the longitudinal ends, and the negative electrode comprises a rod placed along the reactor axis within a reactor interior volume. In this embodiment, the resonant coils are in a linear configuration of a frequency bypass coil, two amp inhibiting coils, a secondary coil, and a pick-up coil along the reactor axis.

In still another embodiment, a spherical housing is provided for retaining the electrodes within a spherical housing interior volume and for retaining the plurality of coils along a housing exterior surface. The positive electrode can include a spherical conducting ball retained at a center of the spherical housing and affixed to a spinning shaft. The negative electrode can include a spherical outer edge rim defining an interior surface of the spherical housing interior volume. The laser cluster array can include components mounted along the housing exterior surface and directed toward the center of the spherical housing. A cylindrical electron extraction perforated grid plate-tube is provided and centered around the positive electrode. The resonant coils are in a linear configuration of a frequency bypass coil, two amp inhibiting coils, a secondary coil, and a pick-up coil acting as an Inductive Recovery Coil.

In a further embodiment, a toroidal housing is provided for retaining one or more of the electrodes within a toroidal housing interior volume and for retaining the plurality of coils along a housing exterior surface. The positive electrode includes a spherical cylindrical surface retained at a center of the toroidal housing, while the negative electrode includes a toroidal member defining an interior surface of the toroidal housing interior volume. A centrally mounted toroidal conducting ring grid-plate is configured within the toroidal housing interior volume. The resonant coils include a poloidal configuration of resonant coils around a latitude of the toroidal housing for inducing electron curl effects between the electrodes, and a toroidal configuration of resonant coils around a longitude of the toroidal housing placed perpendicular bisector to the electrodes.

Other benefits and advantages of this invention will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiment of which will be described in detail in this specification and illustrated in the accompanying drawings which form a part hereof and wherein:

FIG. 1A is a schematic depicting a normal electrical mode of a capacitor as an “imaginary load” and the “Closed-Loop” circuit (Faraday Electrolysis) in accordance with the present invention.

FIG. 1B is a schematic depicting negative differential electron pressure 19, 16, and 17 electrical modes to a capacitor matrix in the form of an RLC resonant tank circuit in accordance with the present invention.

FIG. 1C is a schematic depicting a PCB board transistor drive unit 20 in accordance with the present invention. The drive unit is capable of sequential triggering. This is fed by unipolar pulse 44 bursts from the sequencer board 30.

FIG. 1C1 is a schematic depicting a PCB board sequencer drive unit 30 in accordance with the present invention. CD4017 decade counter establishes sequencers timing. The 555-timer chip sets clock timing to CD4017. The two 7408 chips are logic gates establishing sequentially driven unipolar pulses 44 to transistor drivers 20.

FIG. 1C2 is a schematic view of the PCB 20 board with transistor matrix interfacing a PCB board 30 in accordance with the present invention.

FIG. 1D is a schematic diagram of resonant coils L1, L2, L5, L6 Quad-Coil-Transformer i.e., the Arc Reactor™ transformer 10 base mode trigger of high-level fusion (electron cavitations 18) in accordance with the present invention.

FIG. 1E is a schematic of the LED cluster or laser beam array 40 interfacing with the resonant cavity 10, dielectric mediums 32 and electrodes 11, 12, 13, 14 in accordance with the present invention. The lasers 40 or electromagnetic radiation wave packets 41 destabilize the electron orbital cloud and ultimately the nucleus of the atom.

FIG. 1F is a perspective view of a base-mode design construction of the Arc Reactor™ transformer 10 in accordance with the present invention. The embodiment employs magnetic confinement MCF, inertial confinement ICF, magnetic targeting MTF, field-reversal confinement FRCF, stellerator, and plasma acceleration fusion PAF applications.

FIG. 1F1 is a perspective view of a Magnetic Particle Accelerator Core 50 filled with magnetic gas or carbonaceous liquid slurry affixed in/or around resonant cavity 10 in accordance with the present invention.

FIG. 1F2 is a perspective view of the Magnetic Particle Accelerator Core 50 non-magnetic tube single 52 and multi-spiral 53 constructions in accordance with the present invention. Spiral dividers 53 enhance the magnetic field flux-lines 58 to the pick-up coils.

FIG. 1F3 is a schematic drawing of the Magnetic Particle Accelerator Core 50 affixed with an externally driven Electromagnetic Pump 56 assembly in accordance with the present invention.

FIG. 1F4 is a schematic drawing of an Electromagnetic Pump 56 assembly driven by AC mains voltages with a discharging capacitor C1. A switching direction option is available via SW1 in accordance with the present invention.

FIG. 1F5 is a schematic of the Electromagnetic Pump 56 assembly affixed with a ferromagnetic Bar Keeper 57 driven by AC mains voltages or a pulsing network 20 in accordance with the present invention.

FIG. 1F6 is the emission (PulseTor SDD) values of the Arc Reactor™ during operations for 60-seconds. PulseTor detector was used for analysis. Fe55 calibration sample [6 keV], Arc Reactor™ [0.7 keV-40 keV], and galactic center [0.7 keV-50 keV] can be seen. The overlay is from a galactic body center (blackbody radiator) showing similarities with the Compton Hump emissions (20 keV-50 keV).

FIG. 1G is a schematic of the Arc Reactor™ transformer 10 utilizing the resonant coils L1, L2, L5, L6 of the Quad-Coil-Transformer QCT design for enhanced fusion applications. CT connection connects to a secondary coil L3 in accordance with the present invention.

FIG. 1H is a perspective view of a wiring bifilar, trifilar and quadfilar coil wrapping design for iron E.I cores, toroidal core 22, and/or magnetic particle accelerators cores 50 in accordance with the present invention.

FIG. 2A is a cutaway view of an Inertial Magnetic Reverse Field Confinement Plasma Accelerator [Warp-Core] ICF device in accordance with the present invention. The device compresses the negative differential electron pressure 19 into a focal point via Reverse Field Confinement RFC while the anode 11 spins/rotates to centripetally electrostatic forces outwards inducing dynamic resistivity.

FIG. 2B is a cutaway view of the resonant coils L1, L2, L5, L6 within the Inertial Reverse Field Confinement Plasma Accelerator fusion device [Warp Core] ICF in accordance with the present invention.

FIG. 2C is a schematic view for the operational Inertial Magnetic Reverse Field Confinement Plasma Accelerator (Warp-Core) ICF device in accordance with the present invention. 60 hz (1^{st} harmonic) is established through ballasting L4 coil, while 120 hz (2^{nd} harmonic) is established through bridge rectifier to anode 11. And finally, a 2.66 KHz (3^{rd} harmonic) is established with a transistor network to ionic accelerators electrodes 11, 14, while a transistor network 20 causes ionic accelerations 11 within the resonant cavity 110.

FIG. 3A is a cutaway view of the Electro-coagulation Water Purification Fusion device in accordance with the present invention. Water flow is directional through the reactor 210. Exciter plates 11, 12, 13, 14 are pancake stacked plates that allow longer processing exposure duration. Resonant coils L1, L2, L3, L4, L5 are axially wrapped outside the resonant cavity 210.

FIG. 4A is a cut away view of the Inertial Confinement ICF laser apparatus in accordance with the present invention. The anode 11 is centrically mounted in line with the laser array cluster 40. The resonant unipolar pulsing coils L1, L2, L3, L4, L5 are axially placed around the cathode 12 spherical housing. The anode 11 may rotate to induce enhanced dynamic resistance 19 effects. An electron extraction E.E. grid is placed around the anode 11.

FIG. 5A is a cut away view of the Magnetic Confinement Fusion MCF device—Tokamak reactor in accordance with the present invention. A donut shaped resonant cavity 410 is wrapped with longitudinal poloidal resonant coils L1, L2, L3, L4 while toroidal field coils L5 and L6 are wrapped perpendicular to the centrally place exciter anode 11. The plate 13 is a ring electrode for Electron Extraction E.E. merger enhancement. The laser wave emitter 40 is affixed off-center to the anode 11. The cathode 11 is the outer shell of the reactor.

FIG. 6A is a cut away view of the dynamic resistance pointed-cathode wet cell device in accordance with the present invention. Water flow is directional through the reactor 510. Exciter plates 11, 13, and 14 are pancake stacked plates that allow longer processing exposure duration. Resonant coils L1, L2, L3, L4, L5 are axially wrapped outside the resonant cavity 10. Pointed carbon-cathode 12 is adjusted to a specific height just above or below the liquid dielectric line.

FIG. 7A is a cut away section of an enhanced anode 11 multi-channel cavity magnetron electrode 8 affixed longitudinal position with exciter electrodes 12 and 13 in reference to the external Helmholtz/Maxwell coils (Tri-Coil transformer—TCT) resonant cavity.

FIG. 7B is a zoomed in cut away section of the anode 11 multi-cavity magnetron 8 in conjunction with laser cluster array 40. Delrin (Acetal) cap is used to affix cavity magnetron around exciter array electrodes 12 and 13. Diffraction grading lens 42 is placed over the LED cluster array 40.

### IV. DETAILED DESCRIPTION

Reference is now made to the drawings wherein the showings are for purposes of illustrating embodiments of the article only and not for purposes of limiting the same, and wherein like reference numerals are understood to refer to like components.

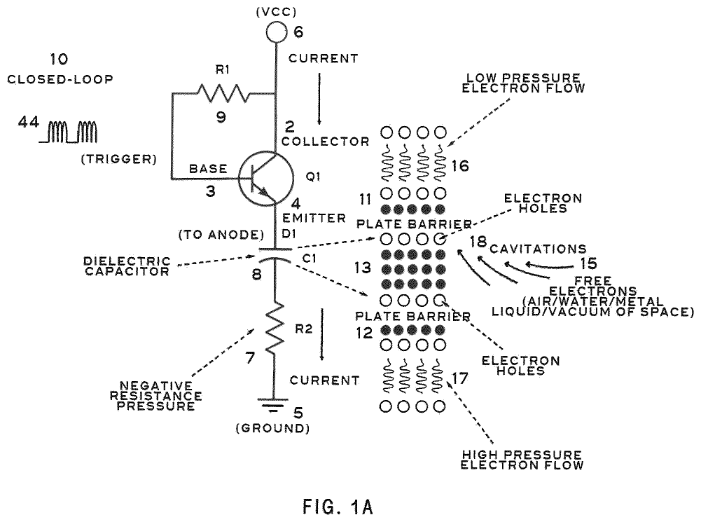

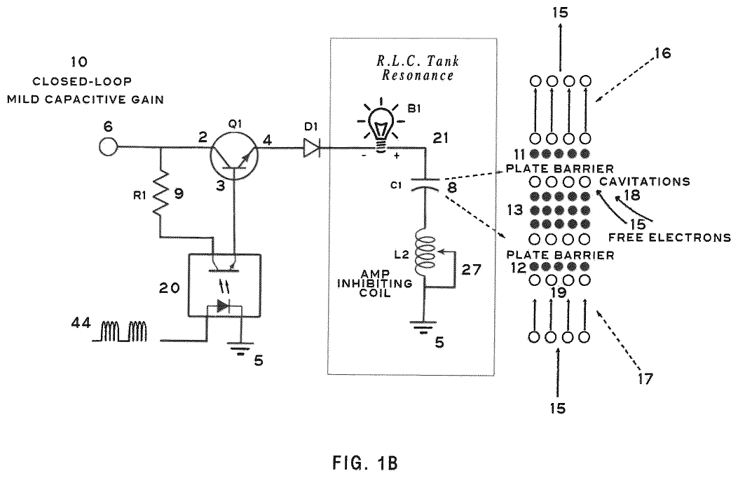

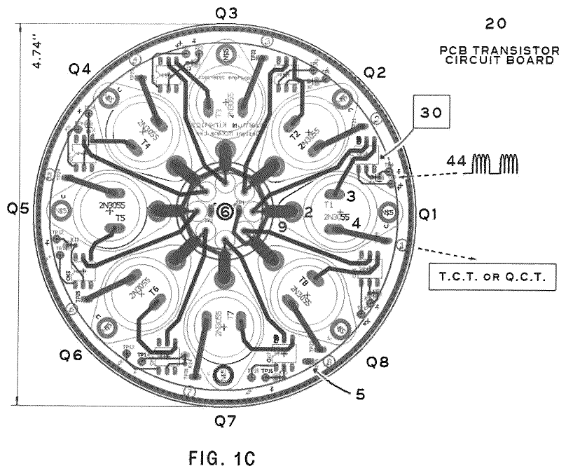

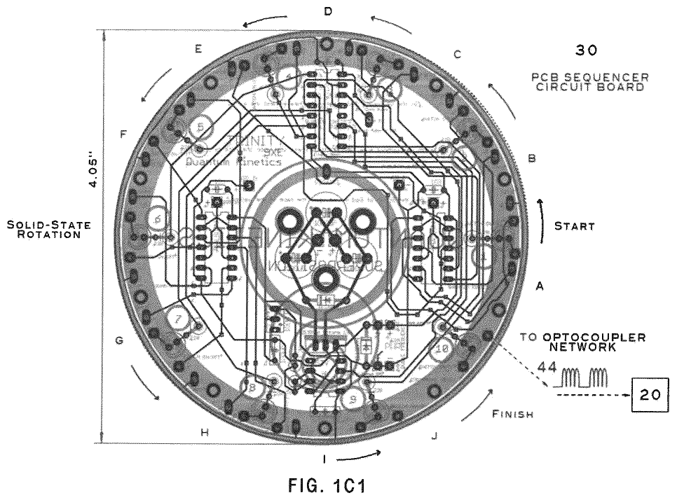

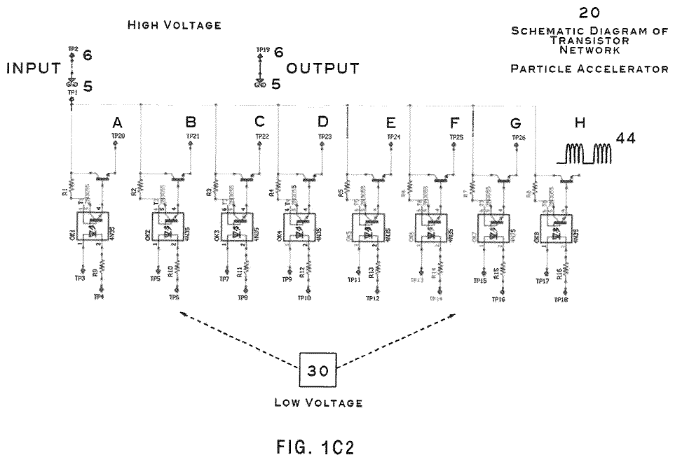

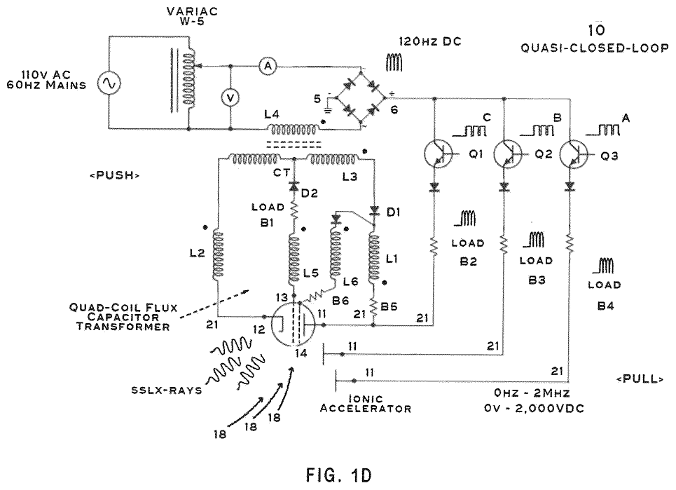

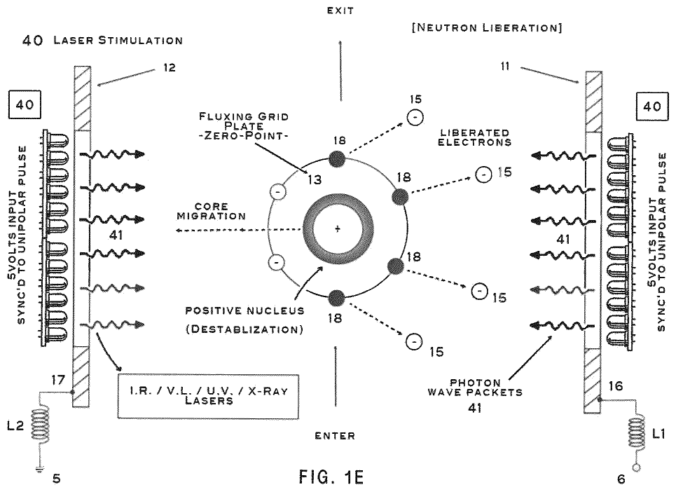

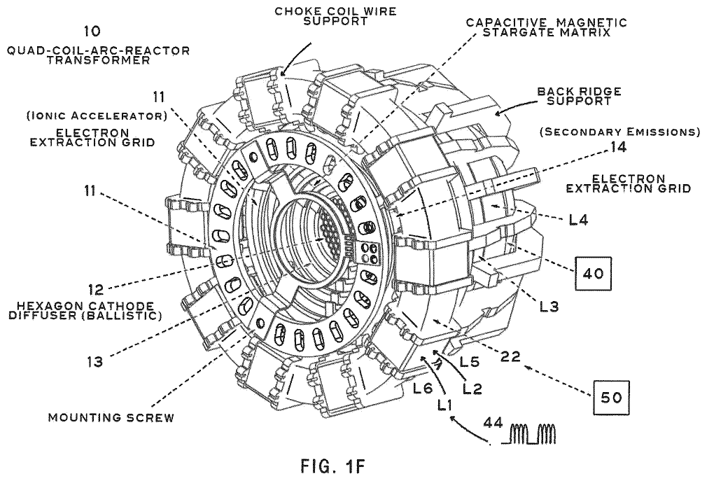

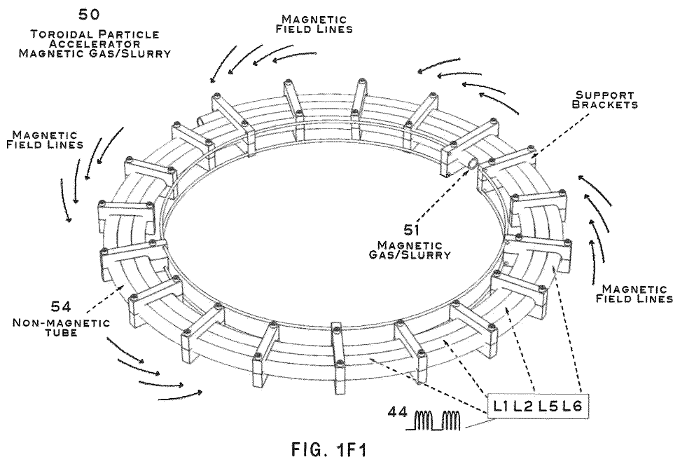

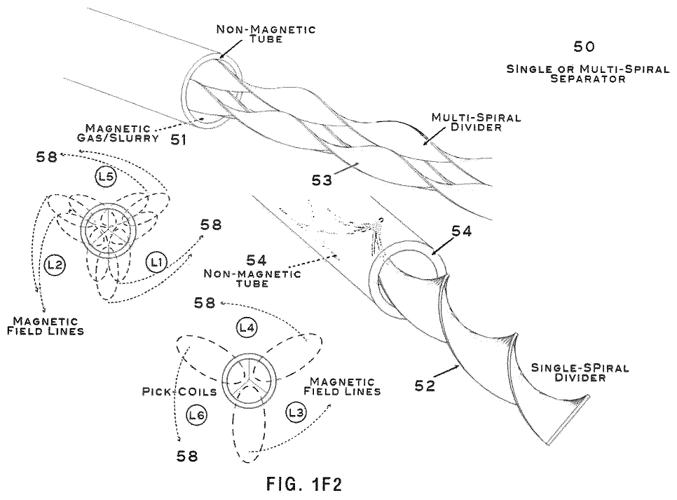

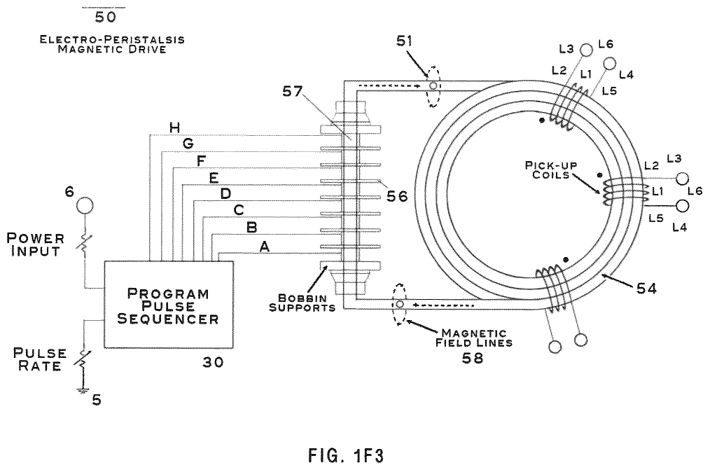

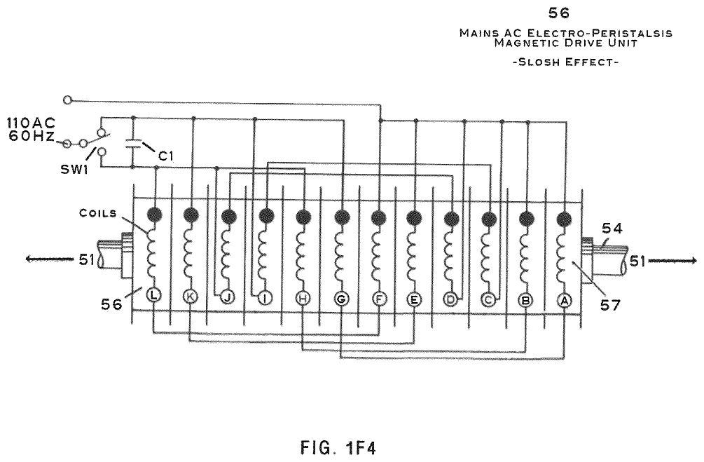

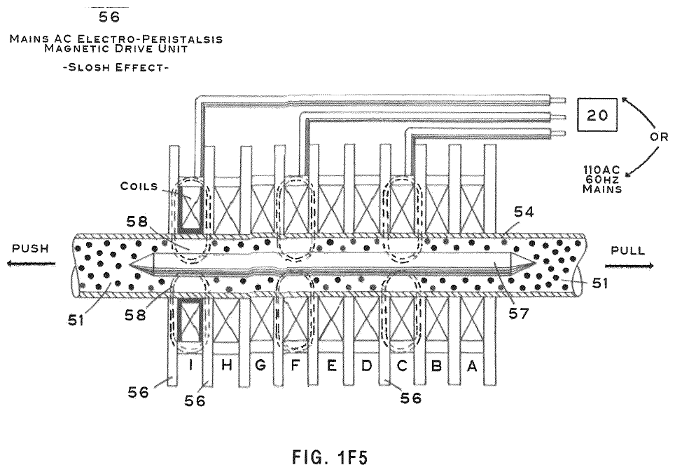

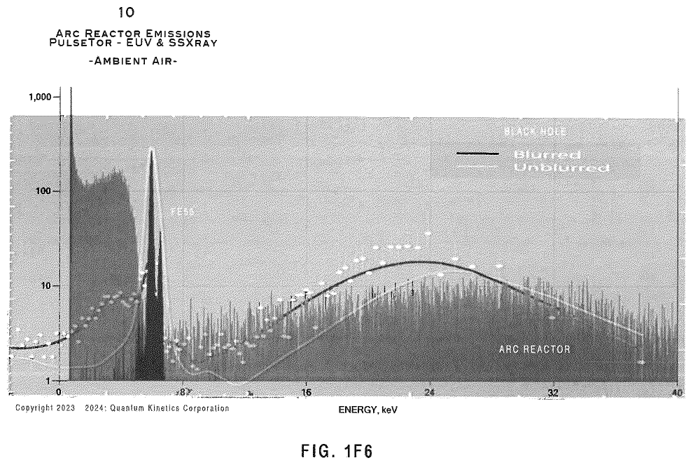

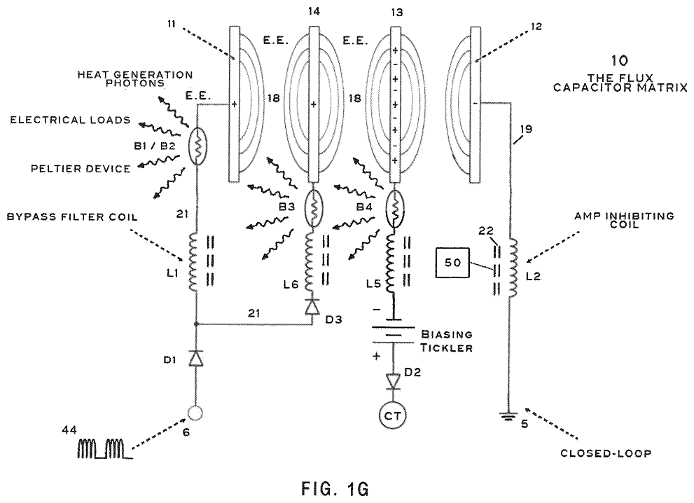

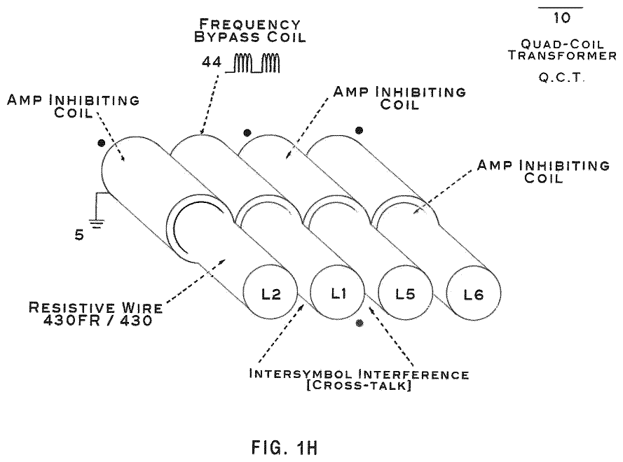

As shown in FIG. 1A, a semiconductor or a series of semiconductors (electron hole donors or absorbers), typically a NPN, or PNP, an SCR, H-Bridge, JEFT, or MOSFET type transistors Q1 are arranged and sequentially pulsed in series or parallel to a capacitive anode 11 from the transistor's emitter 4 within a “Closed-Loop” 5 or “Quasi-Closed-Loop” electrical capacitive load device i.e. resonant cavity 10 (enhancement of wave motions—Mode Locking). Unipolar pulsing 44 of Q1, Q2 . . . establishes resonance within the “Closed-Loop” circuit 5. (See also FIG. 1B, 1C, 1C1, 1C2.)

As additionally shown in FIG. 1A, a (bridge rectified) 12v modified sine wave inverter [AC 60 Hz to DC 120 Hz] 6 can act in response to the unipolar pulse 44 square-wave burst(s).

In conjunction with the transistor Q1 network matrix, the present invention includes a uni-coil L1, bi-coil L1, L2, or tri-coil L1, L2, L5 and/or quad-coil design L1, L2, L5, L6 resonant cavity transformer 10 (FIG. 1D) that utilizes the dielectric properties (dielectric constant, resistance, permittivity, and capacitance) of a material acting as part of a “Closed-Loop” electrical (Resistor, Inductor, Capacitor) RLC resonant circuit. (See FIGS. 1B, 1D, 1G, and 1H.) The L1 coil acts as the frequency bypass coil allowing the unipolar pulse 44 to travel to the capacitor plate 11. Coil L2 is the amp inhibiting effect upon the impinging electron current from L1 and L2 due to opposite magnetic pole repulsion. The resonant coils L1, L2, L3, L5, L6 can be copper magnet wire, 430FR, or 430F Stainless Steel high ohm resistance material lattice. Establishing 11.6 KOhms or resistance per-coil is enough to completely impede ground state 5 electron flow to the pulsing power supply 6. Coils L5 and L6 act in a similar fashion to L2, but further aid the opposing magnetic field repulsion (Cross-Talk) stemming from L1. (See FIG. 1H.) The Pick-up coil L4 or Quad-Tri-Coil (QCT) can be wrapped around a toroidal filled gas/liquid slurry accelerator core 50. (See FIGS. 1F, 1F1 and 1F2.)

In the preferred embodiment, a resonant cavity 10 is constructed with a positive electrode 11 and a negative electrode 12 and is concentrically located in the interior of the housing (resonant cavity) 10, centered on the cylindrical axis. The positive 11 and negative electrodes 12 are plate/cylindrical/spherical/rings and spaced to define the flow passage therebetween. The cathode emitter 12 is a cylindrical sheet with perforated 0.0015-inch to 0.236-inches hexagonal cutouts. This super-geometric focusing Fermi emitter design amplifies ballistic primary electron scattering from cathode hexagon edge(s) 12 (Dirac Holes). (See FIG. 1F.) The positive 11 and negative 12 electrodes create an electrostatic field pressure within the flow passage to dissociate the dielectric medium 32 with negative differential electron pressure 19, 18, 16, 17. A perforated grid-plate/ring 13 is centrically mounted respectively between the anode 11 and cathode 12 to aid dynamic resistivity [electrostatic resistance+diffraction patterns]since this electrode typically swings rapidly positive (+) and negative (−) during unipolar pulse 44 trains at resonant frequency. (See FIGS. 1D and 1G.) A perforated grid-plate or metal ring 13 is a center-tapped CT with a high voltage secondary L3 coil. The perforated grid-plate/ring 13 aids in swinging the dielectric ion pressure 15, 16, 18 over and between the zero-volt reference frame(s). Perforated circles or hexagon holes can range from 0.05 mm to 6 mm for maximized electron diffraction polarization [Fraunhofer/Fresnel—Dirac Points]. This spiraling/oscillating polarization point-like mutually inferring behavior confuses the time-share rate of the electron (−) and positron (+) update function [Planck's constant] due to pulsed voltage crossover phenomenon [Cornu's Spiral]. Mathematically, this is called “equilibrium point” between a sink (+ charge − anode) and a source (− charge cathode) manipulating electron holes and points. The constant solution of the differential of the equation is: [dx/dt=f(t, x)]. This is the uniform motion saddle equaling a zero charge at the CT point of the transformer into the dielectric medium 32 (Dirac Point enhancement). The voltage crossover i.e., equilibrium point (resonant AC/DC signals) is stimulated instantly within the dielectric 32 at resonance and is vectored by the perforated holes of grid-plate 13. (See FIG. 1D.) The perforated grid-plate/ring(s) 13 can be biased (+) positively or negatively (−) for enhances voltage perturbation tickling effect(s). (See FIG. 1G.) The Zero-Point Energy space-charge polarization (Adiabatic Region) of the atom, electron(s) and even subatomic particles occurs in this stance (Electrical Polywell Trapping). A secondary power supply 6 can be affixed between L5 and CT of the secondary coil L3 to bias voltage perturbations either (+) positively or (−) negatively as needed.

The uni-coil, bi-coil, tri-coil or quad-coil transformer or TCT/QCT is electrically tuned to the dielectric 32 properties of a suitable material by a unipolar pulse burst 44, which can be ambient air, water, water mist, liquid metals, and vacuum of space. (See FIGS. 1D and 1G.)

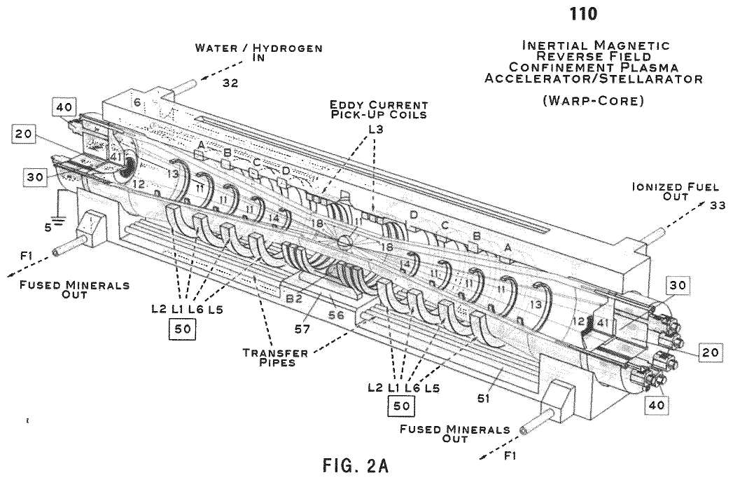

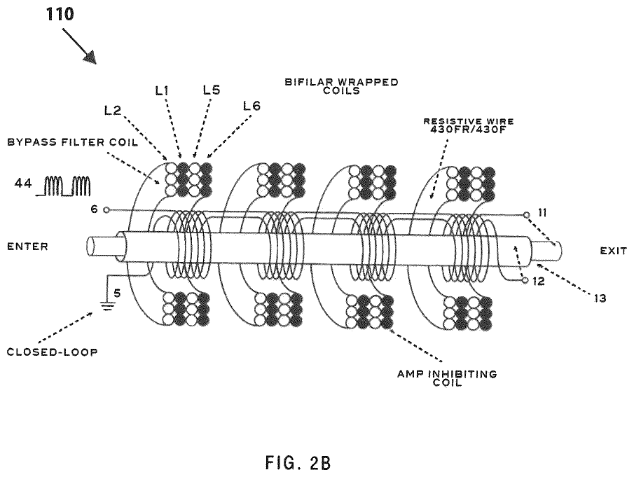

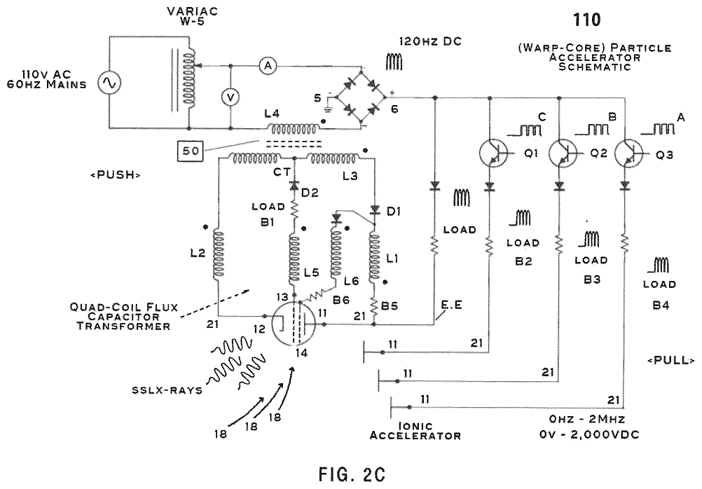

As shown in FIGS. 1H, 1G, 1F1, 2A, and 2B., the coil wraps of the TCT/QCT can be a uni, bi, tri, or quad coil transformer wrapped externally around or internally inside the resonating capacitive cavity 10 (i.e., spherical, doughnut, toroidal—Tokamak, and/or concentrically mounted around electrodes). Coil designs can employ Maxwell, Helmholtz, Toroidal and/or Caduceus design 22, and/or a magnetic gas particle accelerator 50. The present invention entails a physical (physical electrostatic and magnetic lines of force flux) approach to magnetic inertial confinement fusion (MICF) based on voltage and not amperage to dissociate a selected dielectric medium 32, an approach that is 180-degrees out of phase from traditional Faraday ground state 5 electron current. Prior art fusion devices utilize amperage levels up to and beyond 1 million to 10 million amps within one millisecond second or less, which is not necessary, borderline recklessly dangerous, to induce fusion events. With the present invention, 1.9-4.3 watts/sec or 0.250 amps is all that is required to begin the stimulation of dielectric fusion renormalization (electron positron polarization). An external to internal or internal to external electron emitter gun 8 [gyrotron—maser, klystrons and or EMF magnetron/waveguide] may be aimed to enhance electron microwave plasma density within or outside* the resonant cavity 10. Typically, a resonating cathode 12 or cathode emitter will suffice, but either 1^{st}, or 2^{nd} or 3^{rd} resonance frequency harmonics must be obtained by the anode 11, grid-plate 13, electron extraction grid-plate 14 and cathode 12 element(s) to stimulate fusion at 3.5v×0.250 amps=˜1 watt-see to water dielectrics 32 to enhance the space-charge polarization 16, 17 and 18 merge all resonant harmonic frequencies at the same time into one QCT circuit. (See FIG. 2C.) This super-heterodyne electronic stance liberates thermal, resonance, and periodic fast neutrons from the dielectric medium (Compound Nucleus).

To aid space-charge polarization further, a light/laser assembly cluster array 40 is concentrically mounted around the positive 11 and negative electrodes 12 for pulsing light intensity and targeting electron orbital(s) in the dielectric medium 32 in the flow passage to dissociate the dielectric medium 32. (See FIG. 1E.) The light assembly cluster array 40 is preferably an LED cluster or laser beam cluster. An acrylic lens 41 is retained concentrically between the light assembly laser cluster array 40 around the positive 11 and negative 12 electrodes and centered on the cylindrical axis to disrupt or focus laser photon 41 wave propagation into and around voltage zones of the electrode(s) 11, 12, 13 and 14. Focusing electromagnetic wave energy into, around or outside the dielectric medium 32 and/or onto the electrode “exciters” is the preferred embodiment. Photon energy 41 can even be focused into a desired singularity point to enhance effects. Focusing laser energy with electron ballistic Fermi emissions from the cathode 12 will produce “electron echoes bursts” or commonly known as artificially stimulated Aurora Borealis ionization emissions [electron orbit oscillations in dielectric mediums 32]. See FIG. 16F.

These behaviors are known in electronic physics as, “Free Oscillations” i.e. shock-excited oscillations. This electron manipulation is also known to take place within the ATP-Mitochondria energy factory within low voltage cellular membranes (micro-volts to mill-volts)-Electron Transport Chain.

As shown in FIGS. 1E, 1G and 2A, the pulsating resonant cavity 10 for performing (individual electron) cavitational space-charge polarization 18, 16, 17 also includes a first terminal for applying a +5 to +3850 volt DC pulse to the light assembly cluster array and a second terminal for applying a −5 to −3850 volt DC pulse to the light assembly cluster array. The pulsating resonant cavity 10 also includes an electron extraction grid-plate(s) E.E. 11, 14 to capture electrons migrating from the resonant cavity 10. The LED or laser beam cluster 40 can be placed in series or parallel with electrode(s) 11, 14 and 13 electrodes to energize by E.E. “electron extraction” B1, B2, B3, and B4. A diffraction-grading lens 42 may also be incorporated into the LED or Laser cluster array 40. This amplifies photonic beam splitting effect allowing more dielectric medium 32 electron clouds to be agitated/targeted for Space-Charge Polarization 19. This mode is classified as a self-sustaining oscillation in the system. A voltage regulator can be placed in series with B1, B2, B3 and/or B4 to reach desired voltages to the LEDs or laser photon cluster array 40.

As shown in FIGS. 1H and 2B, in the preferred embodiment, the exterior resonant coils L1, L2, L5, L6 are bifilar coils that establish opposing magnetic field flux fields (Wire—Penning Trap—Intersymbol Interface). The coil pairs are affixed to a plastic air-core, grain orientated E & I core(s), nano-crystalline/ferrite/tape wound toroidal core 22, and/or a magnetic [nano-magnetite]vortex-fluid particle accelerator core (stellarator) 50. (See FIG. 1F1.) Magnetic Particle Accelerator Core [Stellerator] 50 will be discussed in further sections.

Preferably, the dielectric medium 32 is water (hydrogen dense materials i.e., deuterium/tritium-oxide) and the resonant frequency can range from 1 Hz-2 Mhz for dissociation of water into hydrogen, oxygen and electron(s) 32. During unipolar 44 fusion reactions, cathode 12 builds up rare nano-minerals F1 [carbon (organic and inorganic), calcium, silicon, oxides, sulfur, iron, nickel, aluminum, titanium, silver, gold, uranium, and magnetite—organic hydrides]. Ferromagnetic fused material gases or liquid slurry F1 may be used (thus incorporated) into the Magnetic Particle Accelerator Core 50. Fused dielectric medium F1 will fabricate other rare nano-mineral metal-oxide hydrides. During operations, other dielectric media 32 having respective resonant frequencies and voltage inputs can also be employed. Acoustics [20 Hz-20,000 Hz] and Ultra-sonic frequencies [20 kHz-1 MHz] are idle for space-charge polarization 18 due to electrode resonant ringing i.e., phonon (sound) quanta wave propagations through dielectric medium(s) 32, thus fabricating mono-atomic hydrogen and magnetic gases 33. Typically, 2.66 kHz-20 kHz amplifies the phonon events in Stainless Steel 304 exciter electrodes (atomic lattice harmonic vibrations). This is known in science as the “Helmholtz Resonator” effect.

### The Spiral Stellarator Generator (50)

FIG. 1F depicts the general overall layout of the “stacked” i.e., multi-tier tubular particle accelerator affixed to the resonant cavity [Warp Core]110 to enhance space-charge polarization. A spiral stellarator generator may take on diameter sizes from 6-inches to +60-feet.

As shown in FIGS. 1F1 and 1F2, an exterior static accelerator or Electromagnetic Pump 56 acts as a sequential electromotive force driver that “walks or accelerates” the permanently magnetized carbonaceous medium 51, F1 throughout a non-magnetic tubular concentric pathway 54. The sequential driver (Electromechanical Actuator Pump 56) circuit pulses eight electromagnetic coils of the nylon bobbin (800 turns each coil with 24 AWG wire (A, B, C etc. respectfully) in pulsed order to enhance/promote controllable speed, timing and direction flow 3 of the permanently magnetic fluid or gaseous matter 51 in a “walking” manner. (See FIGS. 1F4 and 1F5.) To enhance cooling regulation during operations, cooling fins can be affixed to the Electromagnetic Pump Assembly 56. AC or pulsed DC approaches can be used based on industrial design needs.

With reference to FIG. 1F3, a magnetic keeper bar key 57 (iron rod or 430FR) is affixed within the Electromagnetic Pump Assembly 56 and aids the increased flow pressures of the permanently magnetic mediums within the closed-loop particle accelerator 50. A magnetic key 57 preferably takes up a material structure such as soft iron or a non-corrosive stainless steel material. Magnetic material such as iron-based magnets may also work. The magnetic keeper bar 57 provides a tight air gap promoting enhanced magnetic pulse network coupling to the permanently magnetic medium flow within/throughout the non-magnetic tubular 54 networks. Simply increasing input voltages 6 or increasing the duty cycle of the pulsing circuit board 20 can increase flow of the magnetic gas/slurry 51 along with excitation of the electrodes 11, 12, 13, 14. During long duration run-times, the medium F1 becomes warm or hot (130 to 300-degrees Fahrenheit), which causes unique physical effects.

As additionally shown in FIGS. 1F4 and 1F5, the sequential power input 30 into the Electromagnetic Pump Assembly 56 is used for reorientation (N/S poles) of the permanently magnetized gas 51, not to produce the magnetic field 58 of the permanently gaseous matter. Note: magnetic mediums 58 may also be pumped through accelerator vessel 50 from two separate Electromagnetic Pump Assembly 56 units at each end acting as a “push” and/or “pull” mode. This results in AC electrical outputs. AC frequency domain is determined by pulse rate fire “sloshing” of permanently magnetized gases within the particle accelerator 50.

Magnetic flux lines 58 of the permanently magnetized fluid and/or gaseous matter 51 become magnetically energized by the Electromagnetic Pump Assembly 56 before entering into the spiral-dyne 52 or the multi-spiral separator 53 within the tubular passageway 54. Electromagnetic peristalsis effects from sequential pulsed coils (A, B, C etc.) move the medium in a vertical direction to promote a “rain-down” effect within the stacked assembly [if multi-stack arrangement is used affixed to the Warp Core 110].

The atomized permanently magnetic medium 51 may take on size characteristics of 325-mesh size (0.0017-inches) or smaller within the tubular pathway. Organic carbonaceous-based Fe3O4 (magnetite i.e., dendrite bacteria) is especially advantageous due to its super-paramagnetic linear arrangement and relaxometry. Warp Core sediment fabrication during operations manufactures Fe3O4 nanoparticles that are composed of 20-40% organic matter at appropriate voltage inputs.

When the permanently magnetic medium 51, F1 which is a fused nanoparticle of gas, is exposed to an external magnetic field (in the order of a few milli Tesla (mT) the nanoparticles align with the sequentially driven field exhibiting a highly ferromagnetic property. Following the removal of the external magnetized field 58 from the Assembly Pump 56 the medium slowly renormalizes. The magnetic moment renormalization rate is strongly upon the nanoparticles F1 diameter and whether they are unbound or bound to an external surface i.e., Argon Gas or Helium. Those skilled in the art will engineer for optimized operational parameters. Furthermore, since the Electromagnetic Pump Assembly 56 is continuously pumping, the magnetic field lines of the pick-up coils L4 (or any other affixed coils) are continuously stimulated by permanently magnetic medium 51 flow rate and ultimately to the pickup coils.

As shown in FIG. 1F2, non-magnetic tubular pathways are made from I.D. ⅛-inch-⅜-inch [or larger] plumbing L-Type copper tube with 0.50-inch O.D. dimensions. This material is located in your local plumbing section of any hardware store. Any tubular pathway size or non-magnetic shape material may be used for desired energy outputs or desires. Increasing the dyne twist divider number per inch would increase magnetic flux lines 58 spin and rotation flow. Further enhancing the magnetic flux lines 58 increases “induction-clipping” probability to the pick-up coils L1, L2, L3, L4, L5, L6 via serrated magnetic bar edges. (See FIG. 1F3.)

Both homogeneous masses (liquid slurry or gaseous matter) 51 can be doped with different permanently magnetized carbonaceous atoms to encourage electromagnetic field strength (Iron/Nickel/Cobalt). For single generator configurations 15 psi may be used. 30 psi-40 psi may be used, but ideally, any pressure can be utilized for design effects. Internal pressures of apparatus increase efficiencies of particle accelerator generation 50. Once the device is climatized (sealed off), the vessel may operate underwater and in the deepest regions of space. Naturally, a protective painted coating barrier would be sprayed or painted over the coils, electronics and non-tubular generator.

The permanently magnetized gas/liquid slurry 51, F1 acts as a quantum swirling armature inside the apparatus moving both in a linear motion and spiral rotation at once. Only mechanical, the Electromagnetic Pump 56 or external low voltage EMF linear/spiral excitation is necessary to promote electrical power from the pick-up coils L4 (Electromagnetic Induction). As the magnetic gas/slurry 51 moves, the magnetically charged gas traverses by pick-up coil(s) L4, which generates electrical output energy (AC or DC). The permanently magnetized particles 51 of gas prevent electromagnetic coupling between the orientated coils (Electromagnetic Pump Assembly 56) and the pick-up coils L4. Power input 6 is directed into a sequential trigger 30 and transistor board 20 as inputs to rotate and align the spin of the particles of gas/slurry to produce oscillating magnetic field flux lines. The pulse rate determines the frequency at which the medium passes by the pick-up coil L4. In this configuration, there are no moving parts, contact brushes or elements to wear down. Operational longevity can meet or supersede industry generators and thus stimulate fusion reactors having resonant coils L1, L2, L3, L5, L6.

Magnetic flux lines 58 via induction phenomena from the permanently magnetized mediums 51 are enhanced with a dyne-spiral non-magnetic divider 52, 53. Increasing dyne spiral amount, or multi-spiral channels or a combination of both increases magnetic rotation flux lines 58 to the pick-up coils L4. The dyne-spiral divider 52 may be composed of non-magnetic material such as ⅛-inch-⅜-inch M27 steel or T304¼-inch banding with a thickness between 0.010-inches-0.065-inches. Industrial tubular twist tape or square perforated twist tape can be utilized. Increasing the spiral twists per the turn per inch of the spiral-dyne divider 52 increased the rotational magnetic flux lines 58. Increasing passageway channels also increases the magnetic flux lines rotation rate. Alternating the multi-channel passage dyne-spiral dividers 53 enhances the thermal cooling and magnetic flux proliferation. Increasing twist-turns increase the rate of rotation to the magnetic flux lines to pick-up coils L4. This phenomenon increases electrical power generation and/or space charge polarization of water dielectrics 32 when affixed to the Warp Core 110.

### The Warp Core (110)

FIG. 2A depicts an internalized fusion apparatus called: “The inertial magnetic reverse field confinement plasma accelerator” (Warp Core 110, an embodiment of the resonant cavity 10). This embodiment utilizes the Arc Reactor™ design but incorporates internally two (inward) facing confinement cathode(s) 12. The Fermi-emitters between a SS304 spherical 0.65-inch diameter anode 11 which is affixed and controlled by a centralized brushless spinning motor B2 [counterclockwise or clockwise spin modes can be used]. Modular series or parallel design applications are possible. The diameter confinement of a tapered conical compression waveguide is 2.9-inches O.D. with a finalized tapering down to O.D. 1.25-inches. The resonant cavity 110 compression waveguide is made from Delrin or acrylic [non-conducting material], tapering inward towards the spherical anode 11. As stated above, the cathode(s) 12 are a perforated hexagon cylindrical sheet that is 0.73-inchs in diameter and 0.10-inches thick. A conical compression waveguide zone focuses dielectric mediums 32 toward a center section where the spherical anode 11 is positioned. During operations, the perforated ballistic hexagon of the cathode 12 emits resonant electron pressure(s), which is met with outward frictional pressure from a centrally mounted spinning anode 11. The negative ionic 15 charge(s) is sequentially fired toward the anode 11 along the corridor of a compression section. These charged particles are met with outward positive ionic frictional force(s) [from the spinning anode] into an enhanced fusion impedance turbulence zone 18 (Catastrophe Theory—Inward and Outward forces in balance). The fusion region 18 is focused with pulsed lasers 40, the spinning anode 11, and sequentially pulsed grid-plates rings 13 and 14 respectively. This physical phenomenon is enhanced with the electron extraction E.E. triggering. (See FIG. 1D.)

As shown in FIG. 2A, pick up coils L4 are placed concentrically around the “fusion region” 18. L4 coils are inductively coupled to the eddy currents as an inductive feedback kick (Inductive Recovery) occurs in the dielectric medium 32 during atomic snapping (electron bounce renormalization). L4 can also be used as a <PUSH> feature in line with the adjustable AC or DC input power. (See FIG. 1D.)

Fluxing screen-plate ring(s) 13 are continuously triggered (+/− swinging) during unipolar pulses 44 by CT section of L3 during transformer excitation. Screen-plate 13 electrode(s) act as an ionic check-value allowing a concentration of electron-positron pairs to be modulated and oscillated though a center section of the electrode ring(s) 14. Electron extraction (E.E.) plate-grids 14 are made of progressively dilating rings. The electrode(s) 14 ring dimensions are as follows: O.D. 1.70-inches×I.D. 1.55-inches, O.D. 1.40-inches×I.D. 1.25-inches, O.D. 1.20-inches×I.D. 1.00-inches, O.D. 0.85-inches×0.75-inches, all rings are 0.125-inches thick. During each successive unipolar pulse 44 to A, B, C, D etc. the electro-motive force i.e., ionic flow circulates around the “exciter” electrode rings 14 [field-reversal confinement]. The overall dimensions of the apparatus [Warp Core]110 is 23.93-inches long and 4.515-inches tall. Transfer pipes can be connected in series or parallel arrangements.

As shown in FIGS. 1G and 1E, a series of electrodes 14 are arranged as stages where each subsequent stage is sequentially pulsed to increase the charge/speed effects. Each stage or tier of the system promotes and amplifies the destabilization properties of the dielectric medium through ramping charge polarity. The free electron capture of the anode 11, grid-plate 13, and electron extraction grid plate 14 may feed electronic loads such as light bulbs B1, B2, B3, B4, Peltier devices, fans, brushless motors and any other amp consuming device(s). The interfacing of a LED/LASERS Resistor 40 cluster array can be connected between L1, L5 and L6 of the QCT coils to establish self-sustaining energy oscillations destabilization within the resonate electrical “Closed-Loop” system 32.

As shown on FIG. 1B, the natural harmonic frequencies of the “Exciter” capacitive plates of a plurality of resonant cavities should be matched to the electrical resonant frequencies of the RLC “Closed-Loop” circuit.

Maximum voltage potentials and resonant frequencies 44 can be determined by wrap turn counts of the secondary coil L3 such that, the greater the turn count, the larger the voltage potential on the capacitive plates 11, 12, 13 and 14. Turn count on the coil L1 can also be increased to further stimulate the atomic excitation and decay of the selected dielectric medium 32. In an exemplary embodiment of the present invention, a Maxwell/Helmholtz resonant cavity filled with water dielectric (well water) may resonate [7 KHz] with the following parameters:
L1 (Frequency Bypass): 150 turns (30 awg—resistive wire 430FR)—Per Coil
L2 (Amp Inhibiting): 150 turns (30 awg—resistive wire 430FR)—Per Coil
L5 (Amp Inhibiting): 150 turns (30 awg—resistive wire 430FR)—Per Coil
L6 (Amp Inhibiting): 150 turns (30 awg—resistive wire 430FR)—Per Coil
L3 (Secondary): 1500 turns (30 awg—resistive wire 430FR)
L4 (Pick-Up): 125 turns (22 awg magnetic copper wire)—Vary copper diameter gauge for desired use.

The atomic composition of the electrodes 11, 12 can dictate the fusible substrate F1 within the dielectric medium 32. The electrodes 11, 12 are preferably formed of 304 Stainless Steel. However, the anode 11 can be made from aluminum 6061 to diminish electro-static pitting/erosion (increasing water isotope weight of d18 and dD). This material (SS-304) is not typically ferromagnetic, however once machined, the material's electron dipole moments are aligned to a slight degree, giving the electrodes a modest ferromagnetic property. The anode 11 comprised of carbonaceous hybrid SS-304 enhances erosion corrosion during operations. Aligning the semi-ferromagnetic ring electrodes of machined 304 Stainless Steel within the QCT/TCT allows for an optimized hysteresis curve during operations. The magnetic flux field(s) are thus guided by the electrodes 11, 12 in the resonant cavity 10. The operational frequencies of this transformer TCT, can range from 1 Hz-100 kHz. The magnetic field strength of the primary coil L3 is synchronized with the extraction pulsing unipolar positive input 44.

As shown in FIGS. 1C, 1C1, and 1C1, the grid-plate electrodes 13, 14 can be composed of palladium [Pd], but for economics of the device, 304-SS is used. Interchanging, overlaying, or interfacing electrodes 11, 13, 14 can be used to enhance hybrid metal hydride 51 fabrications. Those skilled in the art will design for specific needs and applications.

As also shown in FIGS. 1C, 1C1, and 1C1, low voltage electrical sub-systems for a pulsing network are possible with modern day integrated chips 30, 20. The 7408, 4017 and the NE555 are just some of the IC chips used to facilitate the proper pulsing network to the tri-coil or quad-coil transformer (QCT). The duration and stability of the operations are reliant upon the systems engineering and calibration of the transformer to the fabricated circuit board designs 20. Transistors (2N6678), Silicone Controlled Rectifiers, phototransistors, diodes, resistors, axial capacitors, potentiometers and other electrical devices must be arranged in a specific manner for proper operations.

The circuit is modular in design to enable a large arrangement of pulse widths, gates, and frequencies. For simplistic applications to the TCT/QCT, commercially purchased signal generators are readily available having a 1 hz-150 Khz PWM pulse frequency duty cycle adjustable module, sold as model number XY-PWM1 at online retailers including eBay and Amazon. This can be fed into the PCB board 30 as the clock-signal. Those skilled in the art will trigger semiconductor mode-locking phenomenon to capacitive water dielectrics for fusion enhancement.

As disclosed hereinabove, the present invention yields unique arrays of fused atomic structures F1 including, but not limited to, magnetite (Fe3O4), organic carbon diatoms—dendrites as immature quantum dots—axons (<30v input), hybrid electrode oxides, hydrides and hydrogen gas fuels. The fused/transmuted structures occur as a direct result of the destabilization-rearrangement process described hereinabove. Higher voltages >60v can manufacture heavier nano-elements F1 such as gold, silver, titanium and even uranium. Those skilled in the art may incorporate this process to manufacture known and unknown atomic structures by simply varying the dielectric medium 32 and the composition of the electrodes 11, 12, 13, 14.

### The Fusion Electro-Coagulation Wet Flat-Cell Plate Vessel (210)

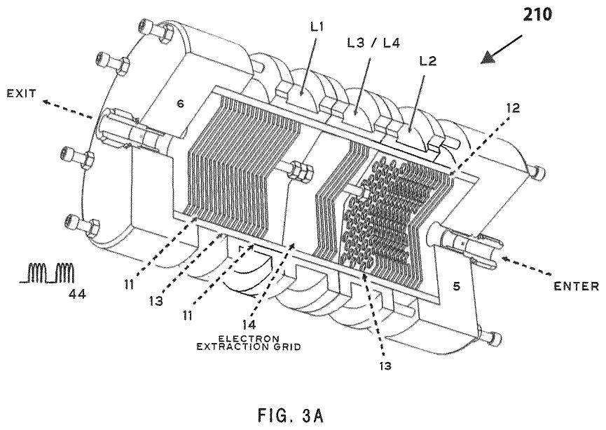

An embodiment is shown in FIG. 3A for linear mode water purification (i.e., electro-coagulation techniques). A 3.55-inches×0.06-inches (16 gauge) thick hexagon or circular flat plate-cell can be arranged axially to the resonant coils L1, L2, L3, L4 thereby establishing a resonant electro-chemical hybrid fusion cell. Capacitive plates 11, 12, 13, 14 are used to increase surface area exposure to the pulsing resonant transformer (TCT) affixed around the exciter electrodes. Plate stack arrangements can alternate between the anode 11, grid 13, and cathode 12. Two ¼-20 nylon or stainless steel bolts supporting screws are placed through the plates to establish linear stance. Nylon washers (¼ inch) are placed between each plate exciter to maintain the electrode gap spacing of 0.063-0.083-inches. Untreated water flows from one side of the reactor through plate matrix to exit port on the opposite side. The coils can be configured as follows:
L1 (Frequency Bypass): 150 turns (19 awg—resistive wire 430FR)—Per Coil
L2 (Amp Inhibiting): 150 turns (19 awg—resistive wire 430FR)—Per Coil
L5 (Amp Inhibiting): 150 turns (19 awg—resistive wire 430FR)—Per Coil
L3 (Secondary): 1500 turns (30 awg—magnet wire—Copper)
L4 (Pick-Up): 200 turns (22 awg magnetic copper wire)—Vary copper diameter gauge for desired use.

The water purification embodiment (i.e., electro-coagulation devices) can take on many shapes, length and sizes. Those skilled in the art will design for proper application flow rate i.e., gallon per minute (GPM).

### The Inertial Magnetic Confinement Lasers (310)

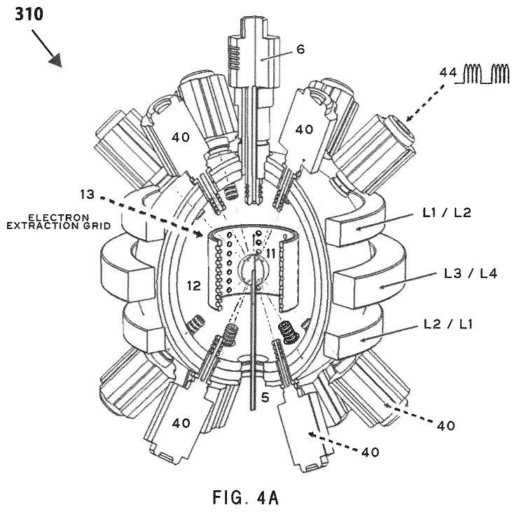

An embodiment is shown in FIG. 4A for a spherical, water filled, resonant cavity 310 system driven by numerous high powered pulsed lasers 40. Pulsed lasers can vary in intensity from 0.10-500 trillion watts-sec. Frequency can also vary from 157-750 nm, however, military frequency may be used 850-1550 nm. In the preferred embodiment, the 660 nm photon (red) frequency is selected. The exciter anode 11 is a spherical polished conducting ball between 0.5-inch to 6-inches in diameter. The anode 11 is affixed to a spinning shaft, which varies rotational speed from 10-+10,000 RPM depending on the laser pulse rate from the array 40. Untreated water flows from one side of the reactor through the plate matrix to the exit port on the opposite side.

In this embodiment, the electron extraction perforated grid plate-tube 13 is placed around the anode 11. The cathode 12 is a spherical outer edge rim of the resonant cavity reactor 310. The outermost spherical section of the apparatus is an insulating material. During the unipolar pulse 44 to the anode 11, the negative electron differential pressure enhances as an electron-plucking action occurs to the dielectric medium 32.

Arrangements of the coils L1, L2, L3, L4 can be affixed either within or without the resonant spherical cavity 310. Unipolar pulse train 44 is timed properly with electron extraction E.E. and pulse rate of the laser cluster array 40. In the preferred embodiment, the B1, B2, B3, B4 act as resistive loads in series with the laser cluster array 40. Thus, energy harvesting from the resonant cavity 310 pulls and/or extracts electrons from the water dielectric 32 to drive the pulsing laser cluster array 40. This electrical configuration ultimately becomes a “self-oscillating” system for “enhanced” energy harvesting. (See FIGS. 1B and 1G.) The coil L4 can be left Open-Circuit as the feedback pick-up coil for energy harvesting during operations if necessary.

The laser cluster array 40 is arranged to point into the core of the resonant reactor 310. The laser cluster array 40 can be aimed at either the anode 11 directly, or at peripheral edges of the grid-plate 13. As anode 11 rotates, the laser wave energy 41 triggers electron cloud migration shearing atomic stability of time-share rate (Coulomb lines of force) of the water dielectric 32. Due to the combination of the anode 11 rotational rates and the laser wave energy 41, the dielectric medium 32 becomes destabilized for direct energy harvesting fusion. The coils can be configured as follows:
L1 (Frequency Bypass): 100 turns (19 awg—resistive wire 430FR)—Per Coil
L2 (Amp Inhibiting): 100 turns (19 awg—resistive wire 430FR)—Per Coil
L5 (Amp Inhibiting): 100 turns (19 awg—resistive wire 430FR)—Per Coil
L3 (Secondary): 3500 turns (30 awg—magnet wire—Copper)
L4 (Pick-Up): 600 turns (22 awg magnetic copper wire)—Vary copper diameter gauge for desired use.

The electrode exciter grid-plate 13 and/or the screen-plate 14 may spin in either a retro-grade and/or prograde rotation in reference to the anode 11 to further stimulate shear flow plasma events within the dielectric medium 32.

The inertial magnetic laser confinement IMLC apparatus can be used for boiling water, extraction electrons E.E electro-physical transmutation of liquid dielectrics 32, and even to ionize ambient air during operations. The exciter anode 11 and the cathode may be electrically energized from 1.9-2,500 watts/sec. However, those skilled in the art will design for safe operational modes.

### The Tokamak Reactor (410)

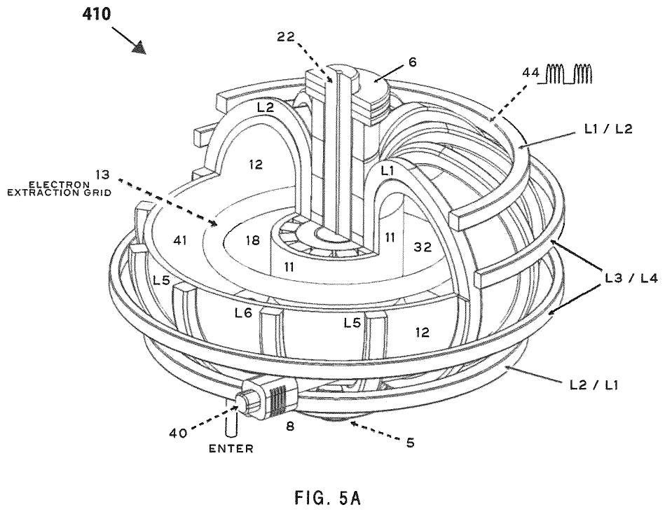

In connection with the further embodiment depicted in FIG. 5A, the primary engineering dilemma associated with the Tokamak (torus style) reactor design 410 is keeping the plasma hot enough (>8.6 keV) for long enough that fusion can occur while limiting the outside walls from melting down. Typically, deuterium gaseous matter is introduced to the (Zonal Flow) space charge polarization region of the reactor. However, by simply stimulating the plasma fusion directly from the water molecules, which acts like tiny semiconductors, which can be amplified, a new type of sustained plasma fusion, can be achieved safely at temperatures well beyond 9 keV-105 million degrees Kelvin.

In this embodiment, a magnetic confinement fusion MCF (a donut shaped reactor) is typically used. This allows for relativistic smooth plasma (electron-ion) flow within the inner walls of a torus shaped reactor, which are controlled by magnetic fields from pulsing coils. A dielectric medium of water is placed in as the semiconducting plasma that is directed away from interacting with the walls, thereby causing damage—“pitting”—by the use of an external magnetic field. Thus, the unipolar pulse burst 44 causes the dielectric 32 to behave like a diode laser causing X-ray photons (1 to 18.6 keV) to be released from ordinary drinking water. The ocean water dielectric medium can and does exceed 200 million degrees Kelvin i.e., +20 keV.

In the present embodiment of FIG. 5A, the Tokamak is affixed with a centrally mounted toroidal conducting ring grid-plate 13 within the toroidal volume of the resonant plasma chamber 410. The coils can be configured as follows:
L1 (Frequency Bypass): 1000 turns (12 awg—resistive wire 430FR)—Per Coil
L2 (Amp Inhibiting): 1000 turns (12 awg—resistive wire 430FR)—Per Coil
L5 (Amp Inhibiting): 1000 turns (12 awg—resistive wire 430FR)—Per Coil
L3 (Secondary): 7500 turns (20 awg—magnet wire—Copper)
L4 (Pick-Up): 1500 turns (14 awg magnetic copper wire)—Vary copper diameter gauge for desired use.

The outer poloidal field coils (latitude coils) L1, L2 induce electron curl effects between the electrodes 12, 11 and 13, while toroidal field coils (longitude coils) L5, L6 are placed perpendicular bisector to the electrodes 12, 11 and 13. A central solenoid 22 can be formed of the coils L3 and/or L4 affixed with a ferrite core or air-type. The coils L3, L4 can be affixed on the outer perimeters acting as a Maxwell coil. Diverter sections can be affixed with the laser light cluster assembly 40.

### The Dynamic Resistance Pointed Cathode Wet Cell (510)

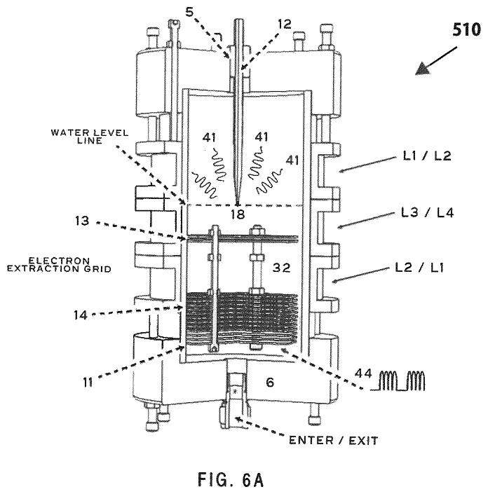

As shown in FIG. 6A, the primary purpose of another alternative embodiment, the Dynamic Resistance Pointed Cathode Wet Cell, is to enhance ‘Quantum Tunneling’ fusion effects during resonance. Field emissions stemming from the cathode 12 to the anode 11 are impinging as a bottleneck electron flow ensues. The cathode 12, which is a ¼-inch round carbon rod, rests along the reactor axis 0.01-inches above or below the water line of the resonant cavity reactor 10. During space charge polarization (unipolar pulses 44), the renormalization event causes an instantaneous ignition of super-heated steam, photon light 41 and or hydrogen oxygen gas polarization.

Resonant coils are placed around the resonant reactor 510 thereby inducing magnetic field line swirling.
L1 (Frequency Bypass): 105 turns (22 awg—resistive wire 430FR)—Per Coil
L2 (Amp Inhibiting): 105 turns (22 awg—resistive wire 430FR)—Per Coil
L5 (Amp Inhibiting): 105 turns (22 awg—resistive wire 430FR)—Per Coil
L3 (Secondary): 700 turns (30 awg—magnet wire—Copper)
L4 (Pick-Up): 500 turns (24 awg magnetic copper wire)—Vary copper diameter gauge for desired use.

### The Quantum Kinetic Fusor—Cavity Magnetron & Orbitrap (610)

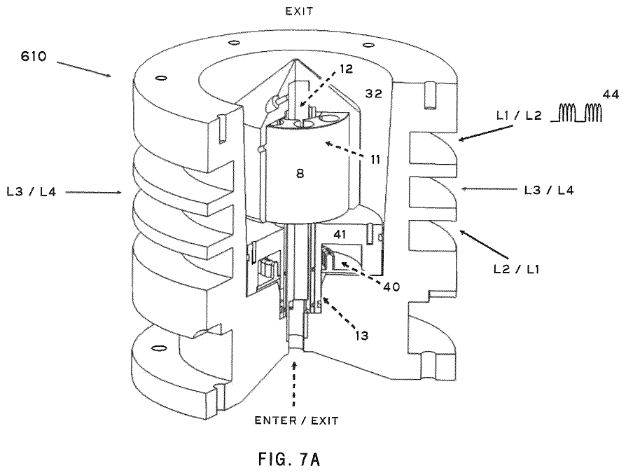

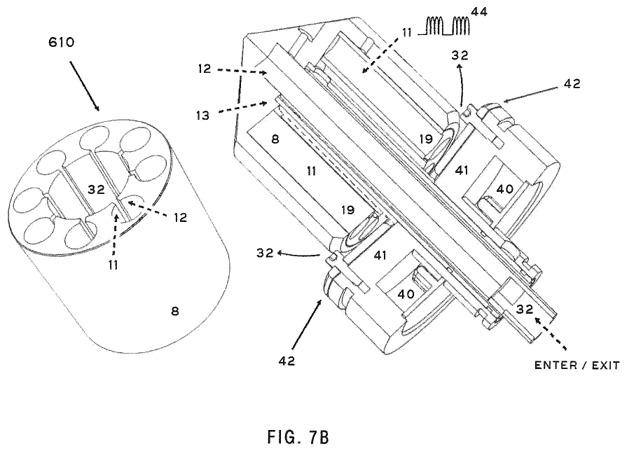

As shown in FIGS. 7A and 7B, to enhance plasma fusion to gaseous matter, water, and/or vacuum dielectrics further, a magnetron 8 shaped anode electrode 11 can be utilized. A magnetron electrode 8, which used as a single cavity (hull) or a series of multi-cavity oscillators, which enhance alternating current electro-magnetic excitation to dielectric mediums 32. These micro-resonant capacitive and inductive shapes can be circular, oval, rectangles, egg shaped, and or spoke wheel shaped in nature. Each cavity, acts as a resonant micro-capacitor inducing electron swirling (bunching action) motion within each cavity 11 and 12. The anode cavity magnetron 8 can take on linear mode as a klystron or single cylindered shape like the hull magnetron and/or cavity magnetron. The primary purpose of this configuration is to enhance velocity-modulated electron energy from cathode 12 and or grid 13 during uniplar 44 operations.

Electrode size may vary for desired specific effects. Those skilled in the art will design for proper energy RLC (resonant) tank circuits for direct electron (energy-electromagnetic fields) harvesting functions and/or dielectric behaviors. Therefore, in this embodiment, the magnetron 8 anode electrode 11 can be 2.4-inches in diameter with a center bored diameter hole of 1-inch acting as dielectric medium interaction space 32. Within the outer walls of the hull magnetron electrode tube 8, there are eight drilled 0.765-inch diameter holes spaced 45-degrees apart with a connecting channel slot gap spacing of 0.050-inches. These gapped slots act as microscopic capacitive (electrostatic and magnetic) networks, which are excited with a specific resonant (RLC tank circuit) action to passing electrons from cathode 12. This construction makes one single magnetron anode electrode 11 into a multi-capacitive RLC tank circuit oscillator 8. This electrode anode 11 is typically stainless steel 304. A variety of material substrates may be used for desired effects. Cathode 12, which is a seamless round tube, is placed longitudinally into the 1-inch bored center magnetron anode 11. See FIGS. 7A and 7B. The cylindrical shaped magnetron anode 11 is placed internally or externally to resonant coils L1, L2, L3, and L4. This establishes a highly advanced resonant electro-magnetic “hybrid-orbitrap” oscillating hybrid fusion cell. Capacitive plates 11, 12, and/or 13 are used to increase surface area exposure to pulsing resonant transformer (TCT) affix around exciter electrodes enhancing electron extraction 44 unipolar pulses from dielectric medium 32.

Resonant coils L1, L2, L3, and L4 are placed around the resonant reactor 10 inducing magnetic “Space-Charge Spoke Wheel” field line swirling rotation. During unipolar pulsing 44 operations, the magnetic field lines of L1, L2, L3, and L4 cause electrons to orbit about the cylindrical axis with an azimuthal drift velocity. Due to electron phase shift variability during unipolar pulse train 44, the magnetron 8 anodes 11, 12 fabricates electron relativistic phase shift (localized electron bunching) within dielectric medium 32. This enhances the dynamic resistance effects (positron—anti-matter tickling) for plasma fusion efficiency via time-share rate rotations. In addition, the cavity magnetron 8 diameter hole sizes emit super-heterodyne electromagnetic (E.M.F.) transient oscillations directly into the dielectric medium 32 (2.4 Ghz) causing electron dipole flipping further aiding in electron/atom time share-rate space-charge polarization (safe low energy nuclear plasma fusion).

A segment coupling ‘pick-up’ waveguide loop may be introduced into one single cavity-oscillating resonator to project radio frequency (R.F.) radiates into the dielectric medium 32. A strap-fed loop, aperture-coupling slot, segmented-fed loop, and/or coupling loop at the end of the cavity resonator may be utilized for electromagnetic energy (pressure) amplification into T.C.T. and or dielectric medium 32.

Magnetron electrode 8 may also employ a tuning element ring and/or multi-inductive tuning element (cylinders). This element can be connected by a tuner frame, which is placed within the individual magnetron 8 cavities 11 and 12 to adjust and give desired RLC resonant frequency outputs (example: M5114B by ATC Radar).

Resonant frequency of magnetron 8 electrode(s) can utilize four different frequency modes. One, π-Mode, which utilizes no connecting tuning bar/ring. All cavity resonators excite during operations. Two, ½π-Mode, this is when only half of the cavity magnetrons fire. Three, ¾π, where three quarters of all cavities are excited. And finally, ¼π-Mode, in which only one fourth of all cavity resonators excite. Those skilled in the art will design for proper resonance induction to dielectric medium 32.

To enhance dynamic and Space Charge Polarization 3 further, simple add a diffraction-grading lens 42 over the LED cluster array 40. See FIG. 7B. LED photons 41 are thus split and diffracted to induce more photon energy to “jitter” dielectric medium 32 electron 10 clouds.

This type of reactor is modular, scalable, and highly effective. Those skilled in the art will modify for desired hydrogen production and/or sediment formation characteristics from safe and sustainable plasma fusion.
L1 (Frequency Bypass): 150 turns (19 awg—resistive wire 430FR)—Per Coil
L2 (Amp Inhibiting): 150 turns (19 awg—resistive wire 430FR)—Per Coil
L3 (Secondary): 2500 turns (30 awg—magnet wire—Copper)
L4 (Primary): 100 turns (19 awg—magnet wire—Copper)

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A reactor device comprising:
electrodes comprising at least a positive electrode and a negative electrode, wherein the electrodes are configured concentrically along a reactor axis to define a resonant cavity;
a flow passage having an entrance port and exit port for flowing a dielectric medium into the resonant cavity, wherein the electrodes create an electrostatic field throughout the flow passage to dissociate the dielectric medium;
a plurality of resonant coils configured concentrically along the reactor axis to surround the electrodes and thereby axially wrap the resonant cavity, wherein each of the plurality of resonant coils are selected from frequency bypass, amp inhibiting, secondary, or pick-up coils;
a rotating or stationary pulsing laser cluster array for pulsing light intensity and targeting electron orbitals in the dielectric medium in the flow passage to dissociate the dielectric medium;
a power supply to which is fed with unipolar and/or continuous resonant cavity pulses with alternating current potential and simultaneously feeding resonant reactor with supplied direct current through synchronized unipolar super heterodyne amplitude modulation resonant pulses via tri-coil transformer matrix;
a coil arrangement consisting of uni-filar, bifilar, trifilar, quadfilar, and/or any variations of electromagnetic cross-talking interrupter coil designs;
a waveguide exciter electrode matrix configuration in longitudinal, spherical, and or cylindered configurations, and
a diffraction-grading lens over LED cluster array to enhance dielectric polarization for fusion.

2. The reactor device of claim 1, wherein the electrodes further comprise at least one perforated grid-plate/ring centrically mounted respectively between the positive electrode and the negative electrode to aid dynamic resistivity.

3. The reactor device of claim 1, further comprising a longitudinal housing having a first longitudinal end and a second longitudinal end with a center therebetween, wherein both longitudinal ends lie along the reactor axis.

4. The reactor device of claim 3, wherein the laser cluster array includes components mounted in at least one longitudinal end, and directed toward the center of the longitudinal housing.

5. The reactor device of claim 3, wherein the entrance port of the flow passage is mounted in the first longitudinal end and the exit port is mounted in the second longitudinal end so that dissociation occurs at the center.

6. The reactor device of claim 3, wherein the electrodes comprise first and second sets of electrodes conically tapered toward the center, and wherein the plurality of resonant coils comprise first and second sets of resonant coils configured concentrically along the reactor axis to respectively surround the first and second sets of electrodes.

7. The reactor device of claim 6, wherein each of the first and second sets of resonant coils are in a linear configuration of an amp inhibiting coil, three frequency bypass coils, and a secondary coil along the reactor axis from a respective longitudinal end to the center.

8. The reactor device of claim 3, wherein the electrodes comprise at least one stack of capacitive plates, and wherein the plurality of resonant coils are configured concentrically along the reactor axis to respectively surround the capacitive plates.

9. The reactor device of claim 8, wherein the resonant coils are in a linear configuration of two amp inhibiting coils, a secondary coil, and a pick-up coil along the reactor axis.

10. The reactor device of claim 3, wherein the positive electrode is configured proximate to one of the longitudinal ends, and wherein the negative electrode comprises a rod placed along the reactor axis within a reactor interior volume.

11. The reactor device of claim 8, wherein the resonant coils are in a linear configuration of a frequency bypass coil, two amp inhibiting coils, a secondary coil, and a pick-up coil along the reactor axis.

12. The reactor device of claim 1, further comprising a spherical housing for retaining the electrodes within a spherical housing interior volume and for retaining the plurality of coils along a housing exterior surface.

13. The reactor device of claim 12, wherein the positive electrode comprises a spherical conducting ball retained at a center of the spherical housing and affixed to a spinning shaft electrode, wherein the negative electrode comprises a spherical outer edge rim defining an interior surface of the spherical housing interior volume.

14. The reactor device of claim 13, wherein the laser cluster array includes components mounted along the housing exterior surface and directed toward the center of the spherical housing.

15. The reactor device of claim 13, further comprising a cylindrical electron extraction perforated hexagon grid plate-tube centered around the positive electrode.

16. The reactor device of claim 12, wherein the resonant coils are in a linear configuration of a frequency bypass coil, two amp inhibiting coils, a secondary coil, and a pick-up coil.

17. The reactor device of claim 1, further comprising a toroidal housing for retaining at least one of the electrodes within a toroidal housing interior volume and for retaining the plurality of coils along a housing exterior surface.

18. The reactor device of claim 17, wherein the positive electrode comprises a spherical cylindrical surface retained at a center of the toroidal housing, wherein the negative electrode comprises a toroidal member defining an interior surface of the toroidal housing interior volume.

19. The reactor device of claim 18, wherein the resonant coils included a longitudinal configuration of resonant electrodes affixed with one of an anode shaped slotted hull or multi-cavity magnetron shaped electrode.

20. The reactor device of claim 19, the anode can be shaped as at least one of a circle, egg shape, oval, square, varying slits, or donut slotted hull.

21. The reactor device of claim 17, further comprising a centrally mounted toroidal conducting ring grid-plate configured within the toroidal housing interior volume.

22. The reactor device of claim 17, wherein the resonant coils include a poloidal configuration of resonant coils around a latitude of the toroidal housing for inducing electron curl effects between the electrodes, and a toroidal configuration of resonant coils around a longitude of the toroidal housing placed perpendicular bisector to the electrodes.
